(19) United States
(12) Patent Application Publication
(10) Pub. No.: US 2015/0235205 A1
(43) Pub. Date: Aug. 20, 2015

(54) SYSTEM AND METHOD OF CONTROLLING AND REPORTING A PRODUCT ACQUISITION, AND OF CONTROLLING THE PROVISION OF A SERVICE TO A CUSTOMER, OR THE ACCESS OF A CUSTOMER TO AN AREA OR EVENT

(71) Applicant: Jozef SEBESTYEN, London Greater London (GB)

(72) Inventor: Jozef Sebestyen, London (GB)

(21) Appl. No.: 14/425,401

(22) PCT Filed: Sep. 2, 2013
(86) PCT No.: PCT/EP2013/068084

§ 371 Date: Mar. 3, 2015

Related U.S. Application Data
(60) Provisional application No. 61/696,231, filed on Sep. 3, 2012.
(60) Provisional application No. 61/803,338, filed on Mar. 19, 2013.
(60) Provisional application No. 61/836,570, filed on Jun. 18, 2013.

(51) Int. Cl. G06Q 20/32; G06Q 20/40; G06Q 30/06

(52) U.S. Cl. CPC G06Q 20/3278; G06Q 30/0613; G06Q 20/4014

(57) ABSTRACT

A system or method for controlling and reporting a product acquisition process from a mobile device with enhanced user experience is described. The method comprises of acquiring the products using a handheld electronic device with an online approach, optionally paying for the products online using a payment service, choosing a collection point and the time when the customer will be ready to collect the product, signalling an assistant that the product preparation needs to begin, signalling that the customer is ready to collect the prepared product and identifying the user by one of the proposed authentication methods so that the user can be granted access to the product or service.

### FIELD OF THE INVENTION

The present invention relates to a method of controlling and reporting a product acquisition, and of controlling the provision of a service to a customer, or the access of a customer to an area or event. Embodiments of the present invention provide for mobile payment with an enhanced user experience. The system, apparatus and methods disclosed, illustrated and claimed in this document pertain generally to a mobile ecommerce system. Embodiments of the present invention relate to a mobile payment system, especially one that is performed from a mobile phone which could be NFC enabled.

### BACKGROUND OF THE INVENTION

Mobile payment is a method where instead of paying with cash, check, credit card or wire transfer, a mobile phone is used to pay for a wide range of products including services, goods and digital goods. There are a number of different existing mobile payment methods:

SMS based transactional payments—the customers have to request the payment via an SMS text message where the payment will be added to their monthly phone bill or online wallet. Once the merchant receives the notification that the payment has been made he can release the paid for goods. The disadvantage of this method is that the SMS messaging is not reliable and the customer could end up waiting for the confirmation for a long time. For the given reason this method is not popular with customers and is not widely used.

Direct Mobile Billing—the customer chooses the mobile billing option during checkout and will have to enter a PIN and a generated token. Once the transaction is successful the customer's mobile account is charged for the purchase. The disadvantage of this method is that the user has to look up the SMS codes and construct the SMS message himself, and the mobile carriers have to support this kind of payment.

Carrier billing—this method has to be integrated into the operator billing platform and requires integration with the operator. Recently this method is improved by enabling mobile application developers to take advantage of this once-click payment approach. The disadvantage here is again the reliance on the support of the operators.

Mobile web payments (WAP)—the customer uses a combination of downloaded or pre-installed applications on the mobile phone and online web pages to make the payment. The protocol used is Wireless Application Protocol. The disadvantage of this method is that the merchant has to make his services available online in the WAP format.

### SUMMARY OF THE INVENTION

According to an aspect of the invention, there is provided a method of controlling and reporting a product acquisition process, comprising the steps of:

at a broker device, facilitating an agreement to provide a product to a customer, the product to be made available at a specified location;

in response to the agreement, transmitting a request from the broker device to a service terminal at the specified location to make the product available at the specified location; and

authenticating the identity of the customer prior to release of the product.

According to another aspect of the invention, there is provided a method of controlling the provision of a service to a customer, or the access of a customer to an area or event, comprising the steps of:

at a broker device, facilitating an agreement to provide the service or access to the customer at a specified location;

in response to the agreement, transmitting a request from the broker device to a service terminal at the specified location to provide the service to the customer, or to provide the customer with access to the area or event; and

authenticating the identity of the customer prior to providing the service or access to the customer.

The authentication steps may be conducted using the service terminal, or may be conducted manually, or using another device. The method may comprise transmitting a tag identifier corresponding to the customer from the broker device to the service terminal, wherein the identity of the customer is authenticated by comparing the tag identifier transmitted by the broker device with a tag identifier provided by the customer at the specified location.

The method may comprise associating the tag identifier with the customer at the broker device by scanning the tag identifier at the service terminal, inputting to the service terminal a code generated by a portable electronic device associated with the customer or generated by a server, transmitting the tag identifier and the code associated with the customer from the service terminal to the broker device, and associating the tag identifier with the customer via the received code.

The tag identifier may be stored on a physical near field communication (NFC) tag or card, and be communicated to the service terminal by near field communication.

In this case, the method may comprise associating the tag identifier with the customer at the broker device by

transmitting, from the broker device to the service terminal, a user identifier corresponding to the customer in association with a code;

transmitting the code from the broker device to a portable electronic device associated with the user;

scanning the physical NFC tag to access the tag identifier of the physical NFC tag at the service terminal;

providing the code received at the portable electronic device to the service terminal and associating the received code with the tag identifier;

at the broker device or at the service terminal, associating the tag identifier with the customer using the association between the tag identifier and the code, the association between the user identifier and the code, and by matching the code received from the broker device with the code received at and provided by the portable electronic device.

In one example, if the code provided from the portable electronic device to the service terminal matches the code transmitted from the broker device to the service terminal, the identity of the customer is authenticated.

The method may comprise storing the tag identifier and the associated user identifier together in a database.

The tag identifier may be a virtual tag stored on a portable electronic device associated with the customer, and may be communicated to the service terminal by a wireless communication method. In this case, the method may comprise pairing the portable electronic device with the customer by

scanning a physical NFC tag associated with the service terminal using the portable electronic device to access a tag identifier of the service terminal;

transmitting the tag identifier of the service terminal from the portable electronic device to the broker device along with a user identifier associated with the customer;

scanning the virtual tag of the portable electronic device using the service terminal;

transmitting the virtual tag of the portable electronic device from the service terminal to the broker device in association with a terminal identifier associated with the service terminal;

at the broker device, associating the received user identifier with the virtual tag of the portable electronic device using the association between the virtual tag of the portable electronic device and the terminal identifier, an association between the terminal identifier and the tag identifier of the service terminal stored in advance at the broker device, and the association between the tag identifier or the service terminal and the user identifier.

The method may comprise transmitting from the broker device to the service terminal the user identifier and the virtual tag, wherein if a virtual tag provided from the portable electronic device to the service terminal matches the virtual tag transmitted from the broker device to the service terminal, the identity of the customer is authenticated.

The identity of the customer may be authenticated by

scanning a physical or virtual tag provided by the customer using the service terminal to obtain a tag identifier;

obtaining a user identifier associated with the tag identifier by referring to a look up table.

The identity of the customer may be authenticated by

scanning a tag associated with the service terminal using a portable electronic device associated with the user to obtain a tag identifier of the service terminal;

transmitting the tag identifier of the service terminal from the portable electronic device to the broker device in association with a user identifier associated with the customer;

transmitting the user identifier received at the broker device from the portable electronic device to the service terminal corresponding to the tag identifier of the service terminal received at the broker device from the portable electronic device.

The identity of the customer may be authenticated by

using a portable electronic device associated with the customer, writing a user identifier associated with the customer into an Near Field Communication tag associated with the service terminal;

using the service terminal, reading the user identifier from the tag.

A preparation start time for the product may be indicated to the service terminal in the request, the preparation start time being determined based on a desired collection time indicated by the customer and a preparation time for the product.

The preparation time for the product may be determined based on historical preparation times.

The preparation time for the product may be determined based on the individual allocated to the preparation of the product.

The service terminal may be operable

to receive an input indicating that preparation of the product has commenced by a particular individual;

to receive an input indicating that preparation of the product has been completed by the particular individual;

wherein the inputted times and/or the time between the commencement and completion of the product preparation are stored and used to generate an estimated preparation time for products of the same type when prepared by the particular individual in the future.

The service terminal may be responsive to the input indicating that preparation of the product has commenced to request the broker device to inform the customer that preparation of the product has started, and responsive to the input indicating that preparation of the product has been completed to request the broker device to inform the customer that the product is ready for collection.

A preparation start time may be indicated to the service terminal by the broker device, the preparation start time being determined based on an estimated arrival time of the customer at the location from which the product is to be collected and a preparation time for the product, wherein the estimated arrival time is calculated based on a current location of the customer with respect to the location from which the product is to be collected.

The current location of the customer may be determined by a portable electronic device carried by the user.

The estimated arrival time may be calculated based on an assumed travel time for the customer between the current location of the customer and the location from which the product is to be collected.

The assumed travel time may be calculated based on one or more of an intended travel path of the customer, and a current speed of the customer.

The method may comprise a step of transmitting to the customer an indication of a collection time at which preparation of the product will be complete, the collection time being determined based on a preparation time for the product.

The collection time may be based on estimated preparation times for one or more items in a backlog queue.

The preparation start times of a plurality of products for which orders are received may be scheduled in dependence on one or more of desired collection times, estimated preparation times of the products, and a deterioration time for the products.

The broker device may store product definitions of products for purchase from services, the product definitions being available for viewing by customers.

The method may comprise providing payment related information to a personal electronic device associated with a customer; and notifying the service terminal that payment has been made.

The method may comprise indicating to the customer a suggested collection point for collecting the product, the suggested collection point being based on the current geographical location of the customer.

The method may comprise the steps of:

receiving at least one product definition information at a mobile device associated with a customer;

using the mobile device, selecting a product based on the product definition information;

determining a payment amount and crediting account;

determining a payment account from which payment is to be made;

using a payment service to perform the payment in relation to the selected product;

sending a payment confirmation to one or more of a service terminal, an assistant intended to prepare the product, and the customer.

The customer may collect the product at a collection point and identify himself to the assistant in order to receive the product.

Identification information may be exchanged between the mobile device and at least one service terminal, or between the mobile device and at least one assistant.

The identification may be provided by exchanging information between the mobile device and at least one service terminal by near field communication.

The identification may be carried out using a static ID, or using a dynamic ID. The identification may be carried out using a pre-existing ID.

A customer tag may be associated with a customer ID or a mobile device may be paired with a customer ID by matching quickcodes.

A customer tag may be associated with a customer ID or a mobile device may be paired with a customer ID after a terminal tag is scanned with the mobile device and the customer tag is scanned with the service terminal thereby allowing a matching process using the terminal ID received from the service terminal and the terminal tag received from the mobile device.

Identification information may be exchanged by reading with the service terminal a simulated NFC identifier from the Mobile Device.

Identification information may be exchanged by reading a tag with the mobile device.

Identification information may be exchanged by writing with the mobile device into an NFC Reader.

Identification information may be exchanged by using a standardized NFC communications protocol.

The product definition may be provided by at least one service and may be stored in at least one data store at at least one broker device.

The broker device may send product preparation scheduling information to at least one service terminal.

The broker device or service terminal may determine when the product preparation needs to start based on a scheduling algorithm which takes into account any one or more of the following information: product preparation time, desired pickup time, location of the mobile device, location of the mobile device determined by a GPS signal, estimated customer arrival time, product preparation time changed, information coming from a computer, information coming from the mobile device.

The assistant may update the product status on the service terminal and a product status may be sent from the service terminal to the broker device and from the broker device to the mobile device.

According to another aspect of the invention, there is provided a system for controlling and reporting a product acquisition process, comprising:

a broker device, operable
to facilitate an agreement to provide a product to a customer, the product to be made available at a specified location; and
in response to the agreement, to transmit a request to make the product available at the specified location; and a service terminal, operable
to receive the request to make the product available, and to display an indication of the request; and
to authenticate the identity of the customer prior to release of the product.

According to another aspect of the present invention, there is provided system for controlling the provision of a service to a customer, or the access of a customer to an area or event, comprising:

a broker device, operable
to facilitate an agreement to provide the service or access to the customer at a specified location; and
in response to the agreement, to transmit a request to provide the service to the customer, or to provide the customer with access to the area or event; and a service terminal, located at the specified location, operable
to receive the request from the broker device, and to display an indication of the request; and
to authenticate the identity of the customer prior to providing the service or access to the customer.

The system may further include a portable electronic device associated with the customer, the portable electronic device being operable to communicate with one or both of the broker device and service terminal to authenticate the identity of the customer.

According to another aspect of the invention, there is provided a method for mobile payment transaction comprising:

receiving at least one Product definition information by a Mobile Device

selecting the Product and collection point on the Mobile Device

determining a payment amount and crediting account from the received Product definition information

determining payment account

using a payment service to perform the payment for the product

payment confirmation is sent to at least one Terminal or at least one Assistant or at least one Customer or any combination thereof.

The Customer may collect the Product at a collection point and the Customer identifies himself to the Assistant in order to receive a product.

The identification information may be exchanged between the Mobile Device and at least one Terminal, or between the Mobile Device and at least one Assistant.

The identification may be in the means of exchanging information between the Mobile Device and at least one Terminal over Near Field Communication.

The identification may be in the means of exchanging information between the Mobile Device and at least one Terminal via wireless communication including but not limited to WAN, LAN, WIFI, AirDrop, 3G, HSPA, Bluetooth, Visual, Sound, Electronic, Touch, Magnetic, Accelerometer or any mobile sensor that is installed in any or both of the Mobile Device and Terminal

The identification may be done using a static ID, a dynamic ID or a pre-existing ID.

The Customer Tag may be associated with the Customer ID or a Mobile Device is paired with a Customer ID by matching Quickcodes.

The Customer Tag may be associated with the Customer ID or a Mobile Device is paired with a Customer ID after the Terminal Tag is scanned with the Mobile Device and the Customer Tag is also scanned with the Terminal thereby allowing the matching process through the Terminal ID received from the Terminal and Terminal Tag received form the Mobile Device.

The identification information may be exchanged by reading with the Terminal the emulated NFC identifier from the Mobile Device.

The identification information may be exchanged by reading a tag with the Mobile Device.

The identification information may be exchanged by writing with the Mobile Device into an NFC Reader.

The identification information may be exchanged by using standardized NFC communications protocol.

The Product definition may be provided by at least one Merchant and is stored in at least one data store at least one Broker.

The Broker may send product preparation scheduling information to at least one Terminal.

The Broker or Terminal may determine when the product preparation needs to start based on a scheduling algorithm which could take into account any of the following information: product preparation time, desired pickup time, location of the Mobile Device, location of the Mobile Device determined by a GPS signal, estimated customer arrival time, product preparation time changed, information coming from the Computer, information Coming from the Mobile Device.

The Assistant may update the product status on the Terminal and the product status may be sent from the Terminal to the Broker and from the Broker to the Mobile Device.

Further aspects of the present invention include a computer program and a storage medium for storing the computer program.

Accordingly, a mobile ecommerce solution with enhanced user experience can be provided where the customer orders a product online and designates a collection point where he will later retrieve the product. The list of available products and the product details can be defined by the merchant and stored by the Broker. The product details may be downloaded from the Broker by an application that the client installs on his mobile device. The customer selects the product he would like to purchase and instructs the application in his mobile device to pay for the product. The application requests the Broker to provide the information that is necessary to initiate the payment transaction and requests the Broker or uses the API of the payment service to perform the payment transaction. The payment service notifies the application or Broker that the transaction has been completed. The Broker sends a notification to the Merchant's Terminal that the product has been paid for. The broker sends a request to the Merchant's terminal to schedule the start of the product preparation. Terminal signals the assistant that the product preparation needs to begin and the assistant updates the product status on the terminal, this status is sent from the terminal to the broker and the broker sends the status to the client. The client receives a notification when the product is ready for collection. The client identifies himself at the terminal, which is preferably done by exchanging the identity information over NFC between a Mobile Device and the Terminal. Once the client has identified himself at the Terminal the Assistant releases the Product Customer paid for. The herein disclosed method may offer the following advantages: it is not dependent on support from the network carrier, it gives the customer the comfort of discovering products and locations that the product is available at, the customer does not have to construct complicated messages to order the product, the customer does not have to stand in a queue while other customers are ordering and paying for products, the customer knows when the product will be available at the collection point, and the customer can identify himself and collect the product with a swipe of his mobile device.

A system or method for controlling and reporting a product acquisition process from a mobile device with enhanced user experience is described. The method comprises of acquiring the products using a handheld electronic device with an online approach, optionally paying for the products online using a payment service, choosing a collection point and the time when the customer will be ready to collect the product, signalling an assistant that the product preparation needs to begin, signalling that the customer is ready to collect the prepared product and identifying the user by one of the proposed authentication methods so that the user can be granted access to the product or service.

### BRIEF DESCRIPTION OF THE DRAWINGS

Embodiments of the present invention will now be described with reference to the following drawings, in which:

FIG. 1 schematically illustrates a simplified communication flow between selected entities of the system;

FIG. 2 is a schematic block diagram illustrating the simplified actions for the Merchant 1000 of FIG. 1;

FIG. 3 is a schematic block diagram illustrating the simplified actions for the Customer 1001 of FIG. 1;

FIG. 4 is a schematic block diagram illustrating the simplified actions for the Assistant 1002 of FIG. 1;

FIG. 5 is a schematic block diagram illustrating the simplified actions for the Broker 1006 of FIG. 1;

FIG. 6 schematically illustrates stage 1 of a product preparation cycle;

FIG. 7 schematically illustrates stage 2 of the product preparation cycle;

FIG. 8 schematically illustrates a process of identification by reading an emulated NFC identifier;

FIG. 9 schematically illustrates a process of identification by reading an NFC identifier with a mobile device;

FIG. 10 schematically illustrates a process of identification by writing with a mobile device into an NFC reader;

FIG. 11 schematically illustrates a process of identification by using a standardized NFC protocol;

FIG. 12 schematically illustrates a process of pairing an NFC identifier with a customer ID using a non-NFC enabled mobile device; and

FIG. 13 schematically illustrates a process of pairing a mobile device with a customer using an NFC enabled mobile device.

### DESCRIPTION OF THE EXAMPLE EMBODIMENTS

One or more specific embodiments of the present disclosure will be described below. These described embodiments are only exemplary of the presently disclosed techniques. Additionally, in an effort to provide a concise description of these exemplary embodiments, only those features of an actual implementation required to understand the invention, and required to put the invention into effect, are actually described. Minor implementation details may not be described in the present specification.

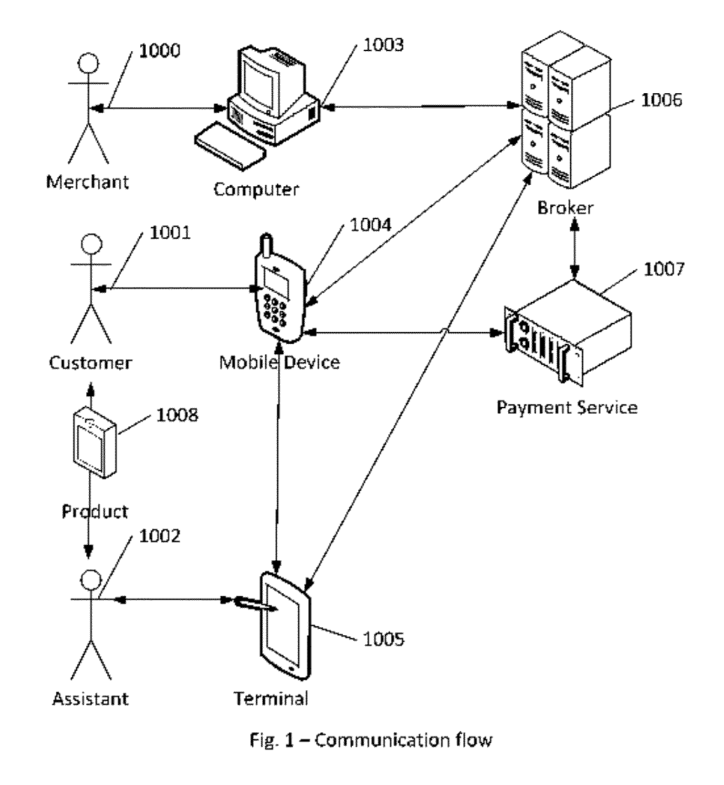

Turning now to the drawings and referring initially to FIG. 1, the following entities are shown:

1000—Merchant: any person, organization, system or entity that wishes to sell a product or products, or to sell a service or provide access to an area or event. It could also be any person, organization, system or entity that is representing the Merchant in some way.
1001—Customer: at least one person, organization, system or entity that wishes to buy one or more products or services, or to obtain access to an area or event; or at least one person, organization, system or entity that is representing the Customer in some way.
1002—Assistant: at least one person, organization, system or entity that is tasked with preparing the product or products, or with providing the service, or access to an area or event. In some cases, this may be the same person, organization, system or entity as the Merchant 1000.
1003—Computer: any computerized device that the Merchant 1000 could use to communicate with the Broker 1006. This device would usually be a personal computer, laptop or tablet. 1004—Mobile Device: at least one device that customer can use to communicate the intent of buying a product or products, or buying a service or access to an area or event. This device is preferably handheld and would usually be a mobile phone or other computerized device e.g. a tablet, watch, glasses or any wearable computerized device. Preferably this device is NFC enabled, but if it does not have an NFC chip it could be fitted with an NFC tag.
1005—Terminal: at least one device that can communicate with the Mobile Device 1004 and Broker 1006. The communication channel between the Terminal 1005 and Mobile Device 1004 would preferably be over Near Field Communication. The communication channel between the terminal and the Broker 1006 would be preferably over the internet, e.g. WAN, LAN, WIFI, AirDrop via Wifi, Bump (bu.mp), 3G, HSPA etc. or any combination thereof but could be any communication protocol. The Terminal could be equipped with an inbuilt NFC chip or by Terminal. Also described is a configuration in which the Terminal is connected to an external NFC reader/writer. This connection could be through a cable, wireless or any other communication method by which information could be transferred.
1006—Broker: A system or service that facilitates the communication between any of the Mobile Device, Computer, Terminal and Payment Service. The Broker could provide some part of the infrastructure that supports the communication, e.g. the Terminal.
1007—Payment Service: at least one service or third party service that provides capability to exchange financial resources e.g. money for the product or products or service or area access, or non-financial resources that represent some value e.g. coupon points, virtual money, any other point system that can be measured and associated with a value. This service would typically be a mobile wallet service e.g. Google Wallet, PayPal, Authorize.net, MasterPass, V.me etc. from a third party and the communication used would be typically be through their proprietary API. The Payment Service could be implemented by the Broker 1006 in which case it would not be third party and closer integration of the Payment Service and Broker would be possible.
1008—Product: at least one but could be a list of many of the following: physical goods, digital goods, services, appointments, electronic ticket, entry access, any result of an act or a process or any combination thereof. It will therefore be appreciated that the term “Product” is to be construed in a broad sense to include the above.

### DEFINITIONS

Customer ID is an information item that is used by the Broker 1006 to uniquely identify the Customer 1001 and typically is linked to a primary key in a table storing Customer 1001 information.

Terminal ID is an information item that is used by the Broker 1006 to uniquely identify the Terminal 1005 and typically is linked to a primary key in a table storing Terminal 1005 information.

Customer Tag is an information item that can be associated with a Customer ID that can be easily processed by the Terminal 1005 e.g. NFC tag, QR code, or information sent from the Mobile Device 1005 to the Terminal 1005 on any communication channel for example but not limited to NFC, Bluetooth, Wifi, AirDrop via Wifi, Visual, Sound, Electronic, Touch, Magnetic, Accelerometer or any mobile sensor that is installed in any or both of the Mobile Device 1004 and Terminal 1005. This Customer Tag could be represented as a static ID, dynamic ID or pre-existing ID.

Terminal Tag is an information item that can be associated with a Terminal ID that can be easily processed by the Mobile Device 1004 e.g. NFC tag, QR code, or information sent from the Terminal 1005 to the Mobile Device 1004 on any communication channel for example but not limited to Bluetooth, Wifi, AirDrop via Wifi, Visual, Sound, Electronic, Touch, Magnetic, Accelerometer or any mobile sensor that is installed in any or both of the Mobile Device 1004 and Terminal 1005.

Quickcode is any information item that can be used as a short authentication token and can be sent from the Mobile Device 1004 to the Terminal 1005, e.g. it could be represented as a short string consisting of letters and numeric symbols. It could be provided manually by the user reading it off the Mobile Device 1004 to the Assistant 1002 and the Assistant imputing this quickcode on the Tablet device, or it could be sent using any other communication method the Mobile Device 1004 and the Terminal 1005 can communicate with for example Bluetooth, WIFI, AirDrop via Wifi, Bump (bu.mp), Visual, Sound, Electric, Touch, Magnetic, Accelerometer or by any sensor that is installed in any or both of the Mobile Device 1004 and Terminal 1005.

In one embodiment the quickcode is represented as one or more character strings. Typically it would be a two character code e.g. “A5”, but it can be any length. Typically it would contain alphanumeric characters and digits, but it can contain any characters, symbols or pictures. If we take a two character code consisting of alphanumeric characters and digits as an example, this would allow the Merchant 1000 to represent (26+10)*(26+10)=1296 combinations. Every order could be associated with a quickcode in a deterministic or heuristic way or by taking a random code from the pool of unused quickcodes. The quickcode pool could be refreshed every day if the pool is big enough for the Merchant 1000 or it could be recycled where after the Customer 1001 has collected the Product 1008 the associated quickcode would be put back to the quickcode pool for potential reuse. The advantage of using quickcodes instead of order numbers is its ease of use, for example the order number could be #35179849 and its quick code could be “ZE”. It would be quicker for the Assistant 1002 to locate a Product 1008 with “ZE” than #35179849 because it takes less effort to remember the quickcode. In one embodiment the quickcode is used for identifying the Customer 1001 or the order which needs to be handed over to the Customer 1001. The Customer 1001 shows the quickcode (e.g. “A5”) displayed on the Mobile Device 1004 to the Assistant 1002 and the Assistant 1002 locates the Product 1008 that is marked with the same quickcode (e.g. with “A5”) and hands it over to the Customer 1001. The benefit of using this approach is that it does not require any wireless technology e.g. NFC or Bluetooth to make it work, and would be applicable with a wider range of Mobile Devices 1004.

An NFC card could be for example but not limited to a wireless payment card that acts as an NFC card, an employee ID card that act as an NFC card, a travelling fare identification card that acts as an NFC card, an NFC tag, sticker or card the Customer that owns or has possession of for any purpose.

NFC identifier—a standard NFC tag, virtual NFC tag, emulated NFC tag on a Mobile Device 1004, NFC card, NFC sticker or other NFC signal that can encode information that could be interpreted as an identifier.

Collection point—this would typically be at least one branch, shop or office of or associated with the Merchant 1000 where he might be selling his Products 1008 to Customers 1001. This collection point could be visually distinguished so that it could be easily located by the Customer 1001.

NFC Reader—if the Terminal 1005 is equipped with an inbuilt NFC reader or chip that may also have a functionality to write data then we mean the inbuilt NFC reader. If the Terminal 1005 is connected to an external NFC reader that may also have a functionality to write data then we mean the external NFC reader.

Preparing the product—by preparing the product it is meant a process in the broadest sense, so it could mean assembling it from parts together, or it could mean packaging a product that is already in its final state, or it could mean any effort by labour to produce the product, or it could mean any act or a process of which the product is a result of, or it could mean selecting an already prepared product as an act of reserving it for the Customer 1001.

According to one or more embodiments of the present invention, methods and systems for mobile payments include ways to enhance the user experience which could mean buying the Product 1008 from the Customer's 1001 current location and appreciating which Collection point is the Product 1008 available at before the purchase or visiting the Collection point, reducing time the Customer 1001 has to spend waiting for the Product 1008 and the ability to discover Products 1008 that are available at locations the Customer 1001 did not have a prior knowledge of.

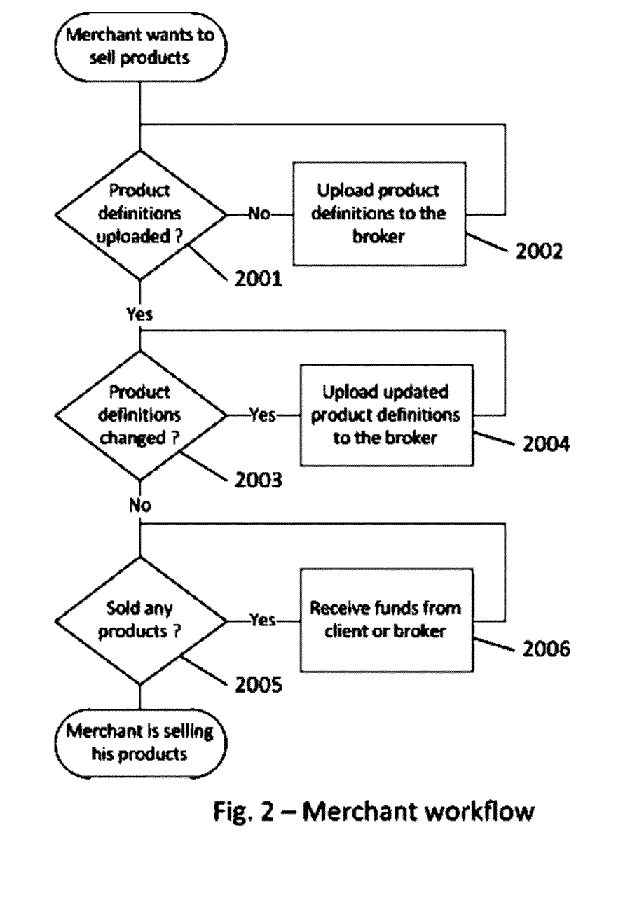

FIG. 2 schematically illustrates the actions conducted by the Merchant, who wants to sell products. In particular, at a first set of steps 2001 and 2002, the Merchant 1000 defines his Products 1008 on the computer 1003 using application software that is preferably provided by the Broker 1006. In particular, at the step 2001 it is determined whether product definitions have been uploaded, and if they have not, then at a step 2002 the merchant 1000 uploads the Product 1008 definition via the application software to the Broker 1006. The Product 1008 definition 2002 could contain the Product 1008 name, price, size, quantity, picture, description, available Collection points etc. The Broker 1006 would store the Product 1008 definition information received from the Merchant 1000 preferably into a database. The Merchant 1000 could download the Product 1008 definitions from the Broker 1006 for editing at a second set of steps 2003 and 2004, and upload an updated version to the Broker 1006. In particular, at the step 2003 it is determined whether any of the product definitions have changed, and if one or more product definitions have changed then at the step 2004 updated product definitions are uploaded to the broker. At a step 2005, it is determined whether any products have been sold, and if they have then at a step 2006 funds may be received from the client or broker.

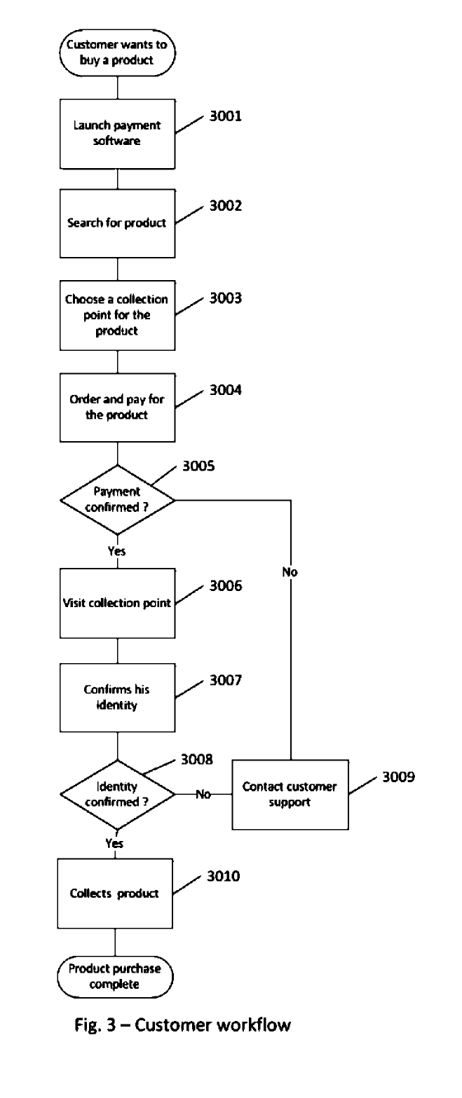

FIG. 3 schematically illustrates the actions conducted by the customer, who wants to buy a product. A mobile application needs to be installed on the Customer's 1001 Mobile Device 1004; it could be pre-installed when he acquires the phone or he could download it and install it on his Mobile Device 1004. Customer 1001 launches the mobile payment software on the Mobile Device 1004 at a step 3001 by any available means including tapping on the screen, using a hardware button, by his voice (in which case voice recognition software has to be operated), on his Mobile Device 1004. The mobile application requests the Product 1008 definitions and downloads them from the Broker 1006, this information could be cached on the Mobile Device 1004. At a step 3002, the Customer 1001 uses the mobile application to search for the desired Products 1008. The search could include any information contained in the Product 1008 definitions the Merchant 1000 has defined combined with any information available from the Mobile Device 1004. For example the search could combine the location of the Customer 1001 provided by the Mobile Device 1004 and the Collection point location contained in the Product 1008 definition to find only Products 1008 that are within the defined distance from the Customer 1001. At a step 3003, the customer selects a Collection point from the Product 1008 definition and defines the time when he wishes to collect the Product 1008. Alternatively the Collection point and the time could be suggested and sent to the Terminal 1005 by the Broker 1006 or mobile application using an algorithm that takes into account how far is the Customer 1001 from the given Collection point; the time the Customer 1001 would need to get to the Collection point based on his velocity; and the time it takes to prepare the product, based on historical data.

At a step 3004, the Customer 1001 uses the mobile application to order and pay for the Product 1008. In case there are more than one Payment Services 1007 available the client can first choose which one he would like to use. There are two suggested approaches to execute the payment: the Direct Payment approach or Broker Aided Payment, in both cases the recipient of the payment could be the Merchant 1000 but preferably would be the Broker 1006 which could make receiving the payment transaction notifications from the Payment Service 1007 easier.

In one embodiment the payment is executed in Direct Payment approach where the payment is communicated directly from the Mobile Device 1004 to the Payment Service 1007, this would require either the Customer 1001 entering his account details (e.g. username and password) with each payment leveraging the security provided by the Payment Service 1007 API, or his details could be stored securely on his Mobile Device 1004 protected by an any alternative form of identification e.g. PIN, Password, biometric, voice recognition.

In one embodiment the payment is executed in Broker Aided Payment where the payment is communicated from the Mobile Device 1004 to the Broker 1006 and from the Broker 1006 to the Payment Service 1007. This has the benefit that a) the Customers 1001 details could be more securely stored by the Broker 1006 and even if the Customers 1001 Mobile Device is lost the customer details information cannot be obtained from the Broker 1006, and that b) the communication channel between the Broker 1006 and the Payment Service 1007 would usually be much more reliable than the communication channel between the Mobile Device 1004 and the Payment Service 1007, so the transactionality of the payment could be improved with the Broker Aided Payment. In the case the Mobile Device 1004 loses communication with the Broker 1006 the payment transaction details could be retrieved by the Mobile Device 1004 from the Broker 1006 once the communication is restored; moreover as described later the Broker 1006 can still send the transaction details to the Terminal 1005 and the Assistant 1002 could start preparing the product; the Customer 1001 could connect the Mobile Device 1004 to the Terminal 1005 via an alternative communication method e.g. NFC and get the payment confirmed that way. An alternative approach would be for the Broker to send the payment confirmation to the Mobile Device 1004 via an alternate communication channel e.g. SMS, via voice over mobile call etc.

In one embodiment the Customer 1001 represents more than one person, organization or entity and they wish to jointly buy the Product 1008, which could represent a list of Products, they could select one of the Customers 1001 to be the leader or host of the payment. The other Customers 1001 could communicate with the host Customer 1001 using their Mobile Devices 1004 to define which products 1008 to buy and choose the amount each of them would like to participate in with the payment. The communication could be performed between the Mobile Devices 1004 or using the Broker 1006 as the hub for the communication.

In case the transaction payment amount is sufficiently small the Broker 1006 could use a debit or credit method to accumulate the small payment amounts together and request a payment from the Payment Service 1007 with a bulk order containing the accumulated payment amount. In the debit method the Broker 1006 would charge the Customer 1001 a minimum payment amount that is greater than the transaction payment amount and have the remaining (transaction payment amount subtracted from the minimum payment amount) amount available for the Customer 1001 for future payments. In the credit method the Broker 1006 would lend funds to the Customer 1001 up to the minimum payment amount, once the Customer 1001 has accumulated payment amount greater than the minimum payment amount the Broker 1006 would request a payment from the Payment Service 1007 with the accumulated payment amount. The accumulation could allow claiming a lower fee rate with the Payment Service 1007. When the recipient of the payment is the Broker 1006 and there is an additional step, 2005 of transferring the funds 2006 from the Broker's 1006 account to the Merchant's 1002 account.

At a step 3005, the mobile application receives payment confirmation either from the Payment Service 1007 or Broker 1006, and notifies the Customer 1001 when the Product 1008 would be available for collection. If the Customer 1001 does not receive a notification he can contact the Customer Support at a step 3009. At a step 3006 the Customer 1001 visits the Collection point and confirms his identity at a step 3007, which preferably is done by placing his Mobile Device 1004 in close proximity to the Terminal 1005 so that the identification information can be communicated preferably over NFC between the Mobile Device 1005 and the Terminal 1005. If the Terminal 1005 is connected to an NFC reader the user could place his Mobile Device 1004 in close proximity to the NFC reader. If it is determined at a step 3008 that the Customer 1001 cannot confirm his identity he can contact the Customer Support at the step 3009. Other identity confirmation channels could also be used including WAN, LAN, WIFI, AirDrop via Wifi, Bump (bu.mp), Voice, biometric, optical, QR, barcode, information retrieved by accelerometer. If the identity confirmation has been successful the customer 1001 collects the product from the Assistant 1002 at a step 3010.

In one embodiment the Mobile Device 1004 is not equipped with an NFC chip, in which case an NFC tag e.g. sticker can be associated with the Mobile Device 1004. In this case the NFC tag could be associated with the user account details. The association could be performed by the Assistant 1002 on the Terminal 1005 usually the first time the Customer 1001 is visiting a Collection point. The association could be repeatedly re-assigned should the NFC tag become invalid or lose the ability to identify the Customer 1001.

In one embodiment the identification is done using a static ID. The static ID is a permanent ID that usually does not change over time and could be used as identification on several occasions but could be used for a single identification purpose as well. The static ID could be stored on any medium that can be used as an information carrying device for example but not limited to NFC tag, NFC chip, NFC card, emulated NFC tag on a Mobile Device 1004, magnetic card etc. In case the static ID is stored on an medium capable of carrying NFC information, the storage of the static ID could be performed by placing the NFC device in close proximity of an NFC reader that is also capable of performing write operations, executing the write operation with transmitting the ID to the NFC medium. Similarly in other cases, when NFC is not used, the static ID could be stored on a medium with a device that is typically used to write the some information to the medium. The static ID could be represented as a string, array of bytes or NDEF message, string representing an URL. The static ID would preferably generated by the Broker 1006 to ensure the uniqueness of the ID, but it could also be generated by the Mobile Device 1004 or the Terminal 1005 or acquired from an external source. In all cases the ID should be sent securely using an encrypted communication protocol e.g. SSH to the device that stores this ID to the NFC device.

In one embodiment the identification is done using a dynamic ID. The dynamic ID is a temporary ID that would typically be used for a single identification purpose but could be used on several occasions as well. The dynamic ID could be represented as a string, array of bytes or NDEF message, an emulated NFC tag, a string representing an URL. The dynamic ID would preferably be generated by the Broker 1006 to ensure the uniqueness of the ID and sent to the Mobile Device 1004 over a secure communications channel, but it could also be generated by the Mobile Device 1004 or the Terminal 1005 or acquired from an external source. The dynamic ID would be transmitted from the Mobile Device 1004 to the Terminal 1005. In case the communication is done via NFC the Mobile Device 1004 could transmit the dynamic ID to the Terminal 1005 in a Peer-to-Peer mode, using Android Beam, using a method that any mobile platform would make feasible e.g. a future communication protocol on iPhone from Apple Inc. or any combination thereof. The advantage of the dynamic ID could be that this dynamic ID could be easily transferred between the Customers 1001 so that a different Customer 1001 could pick up the product, e.g. if one Customer 1001 would want to buy a Product 1008 for another Customer.

In one embodiment the identification is done using a pre-existing ID. The pre-existing ID could come from a pre-existing device. The pre-existing ID could also come from the Customer 1001, in case the pre-existing ID identifies the Customer 1001 with high probability e.g. the pre-existing ID is biometric information. In this case the pre-existing ID would be the biometric ID and in this case the Terminal 1005 could be equipped with or connected to a biometric reader. The pre-existing device could be any device that can carry identification information e.g. NFC tag, NFC chip or NFC card, QR code, magnetic card, a device encoding a visual information, a device encoding auditory information, a device encoding any information that could be used for identification purposes. The pre-existing device could be scanned and associated with the Customer 1001 in a similar way as in the static ID case.

In one embodiment, to associate a Customer Tag to the Customer ID the Broker 1006 generates a Quickcode and sends the Quickcode to the Mobile Device 1004 and the Terminal 1005 with the Customer ID. The Customer 1001 scans the Customer Tag as described above thereby defining on the Terminal 1005 which Customer Tag should be associated with the Customer 1001. The Quickcode is sent from the Mobile Device 1004 to the Terminal 1005. The Quickcode is matched against the Quickcodes paired with the Customer ID received from the Broker 1006 on the Terminal 1005, thereby finding the Customer ID that the Broker 1006 uses for the customer identification. The matched Customer Tag with the associated Customer ID is sent from the Terminal 1005 to the Broker 1006 to be stored on the database. Once the Customer Tag is stored in the database in subsequent transactions the Broker 1006 can send, along with the Customer ID, the Customer Tag to the Terminal 1005 and matched directly against the ID scanned by the Customer 1001 as described above, i.e. if the stored Customer Tag and scanned Customer Tag match the user can be given access to the Product 1008 if not the user could be rejected access to the Product 1008.

In one embodiment, to associate a Customer Tag to the Customer ID the Customer 1001 scans the Terminal Tag with the Mobile Device 1004. The Mobile Device 1004 sends the scanned Terminal Tag with the User ID to the Broker 1006. Next the Customer 1001 scans the Customer Tag with the Terminal 1005. The Terminal 1005 sends the Customer Tag with the Terminal ID to the Broker 1006. The Broker 1006 can match the Customer ID with the corresponding Customer Tag from the recently received Terminal ID from the Terminal 1005 and matching it to the Terminal Tag 1004 sent from the Mobile Device 1004. The matched Customer Tag with the associated Customer ID can be stored on the database by the Broker 1006. Once the Customer Tag is stored in the database in subsequent transactions the Broker 1006 can send, along with the Customer ID, the Customer Tag to the Terminal 1005 and matched directly against the ID scanned by the Customer 1001 as described above, i.e. if the stored Customer Tag and scanned Customer Tag match the user can be given access to the Product 1008 if not the user could be rejected access to the Product 1008.

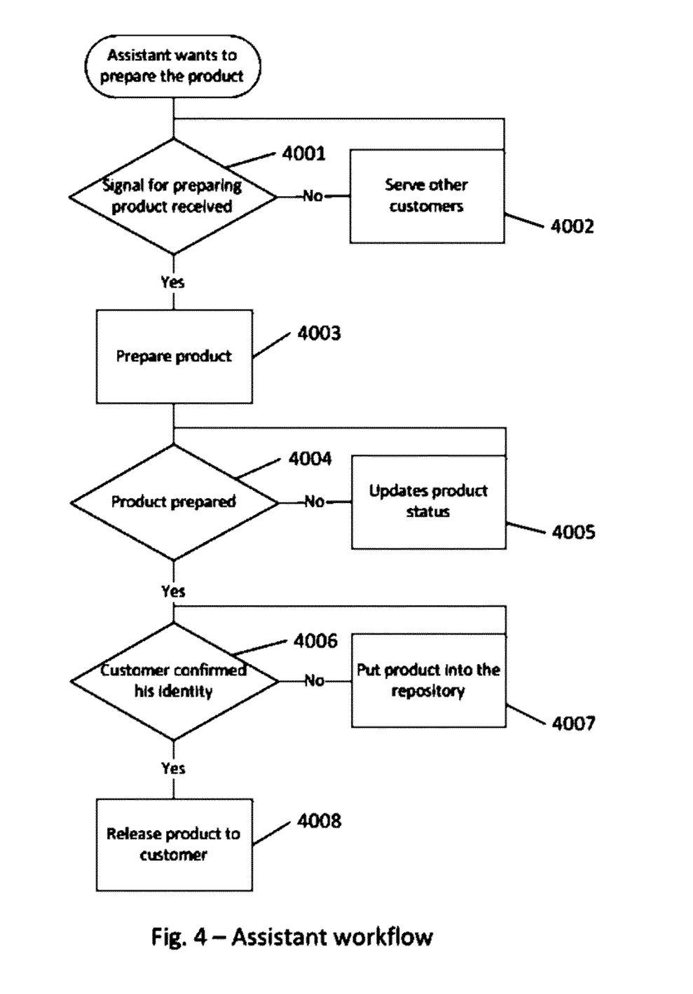

Referring now to FIG. 4, an example assistant workflow is schematically illustrated. In FIG. 4, the Assistant 1002 is serving or preparing products for other customers at a step 4002, when the Broker 1006 sends the order confirmation with scheduling information to the Terminal 1005, the order confirmation is held in a queue and scheduled for preparation at the Terminal 1005. The scheduling may specific a particular preparation start time for the product, determined for instance based on a desired collection time indicated by the customer and a preparation time for the product. Alternatively, the scheduling may merely specify the desired collection time, leaving the Terminal 1005 or another entity to determine from this when preparation of the product should commence. The Broker 1006 updates the schedule when necessary. At the scheduled time, the Terminal 1005 signals at a step 4001 the Assistant 1002 to start preparing the product, which commences at a step 4003. During preparation of the product at a step 4004 the Assistant 1002 updates the product preparation status on the Terminal 1005 at a step 4005. The status could contain information conveying about the completeness of the Product 1008, it could be tracked in percentages where more than 0% means that the Product 1008 is being prepared and 100% means that the Product 1008 has been prepared; or it could be tracked in various states e.g. picked, preparing, half done, almost done, prepared, waiting for collection. Once the product has been completed, it is determined at a step 4006 whether the customer has confirmed his identity. If the Customer 1001 has not been identified yet then the Assistant 1002 labels the prepared product and puts the labelled product into a product repository at a step 4007. By this product repository we mean any storage place where the product could be stored, e.g. at the counter, under the counter on a shelf.

In one embodiment either the Broker 1006 or the Terminal 1005 determines when the product preparation needs to start by a scheduling algorithm or triggered by a scheduling event. The scheduling event could be for example any information coming from the Mobile Device 1004 e.g. the Mobile Devices 1004 location changed or desired pickup time changed by the Customer 1001; or could be triggered by any information coming for the Terminal 1005 e.g. Product 1008 preparation time changed; or could be triggered by any information coming for the Computer 1003. The scheduling algorithm could take into account but not limited to the following inputs: product preparation time by Assistant 1002, when the Customer 1001 wants to pick up the Product 1008, Customer 1001 location, Customer 1001 location determined by a GPS including GLONASS or any other satellite navigation systems signal from the Mobile Device 1004, Customer 1001 velocity or calculated velocity, estimated time the Customer 1001 would arrive at the Collection point from the Customer 1001 travel speed towards to the Collection point and the distance between the Customer 1001 and the Collection point, the backlog queue size for the Assistant 1002.

The Product status is uploaded to the Broker 1006, the Broker 1006 sends the product status to the Mobile Device 1004. The Broker 1006 could send any of the Product 1008 status information to the Mobile Device 1004 on a different channel if there is a need for it, e.g. send it by SMS if the Mobile Device 1004 has lost connection on its main communication channel with the Broker 1006. The Mobile Device 1004 displays a notification to the Customer 1001 when the Product has been prepared. The Customer 1001 visits the Collection point and confirms his identity to the Assistant 1002 at the step 4006, and the Assistant 1002 releases the product to the customer at a step 4008.

The Customer 1001 could be tracked based on its location from the Mobile Device 1004 using either a GPS signal or any other signal that could indicate the position of the Customer 1001. The speed of the Customer 1001 could be retrieved in a similar way from the Mobile Device 1004 or the speed could be calculated from the position of the Mobile Device 1004 at different time points as the Customer 1001 travels towards the Collection point. The path of the Customer 1001 could be calculated based on the Customers 1001 position on data that would represent a map between him and the Collection point or could be retrieved from an external source e.g. Google Maps. From the path it is possible to calculate the distance between the Customer 1001 and the Collection point. From the distance and the speed it is possible to calculate the estimated time the Customer 1001 will arrive at the Collection point. The scheduling algorithm could take into account this estimated time when determining a preparation start time for the product.

Before the Assistant 1002 prepares a Product 1008 he will press a button to indicate that the Product 1008 preparation has started. After the Assistant 1002 finished preparing a Product 1008 he will press a button to indicate that the Product 1008 preparation has ended. By collecting these start and end times it is possible to create any statistics measure that would help with scheduling the Product 1008 preparation times. One measure which could be implemented is the average preparation time for a Product 1008. The average preparation time could be used to calculate the time the system should allocate in the future for preparing the same Product 1008 by the Assistant 1002. For an example if the average Product 1008 preparation for the Assistant 1002 takes 2 minutes and the Product 1008 needs to be ready at 11:43 then the system would queue up the Product 1008 preparation for 11:41 assuming that the queue is empty. If the queue is not empty then the system can move the Product 1008 preparation time forward if the Product 1008 quality does not deteriorate too much with time or move the Product 1008 preparation time onward in which case the Customer 1001 would have to wait for it. This waiting time could be sent back to the Customer 1001 to manage his expectations. More generally, an indication of a collection time at which preparation of the product will be complete can be transmitted to the Customer 1001 at the time of scheduling, when scheduling changes, or upon request by the Customer 1001. The collection time may be determined based on a preparation time for the product. The collection time may also be based on estimated preparation times for one or more items in a backlog queue, each of which may have its own, different, estimated preparation time.

The time it takes for an Assistant 1002 to prepare a Product 1008 could vary greatly based for example on the experience of the Assistant 1002, motivation, and payment incentives. To take this into account the system could keep the statistics separate for each Assistant 1002 or each location or each Merchant 1000. These separate statistics per different entities could serve as a more accurate input used for calculating a more precise scheduling time for the Product 1008 preparation.

The Product 1008 preparation time could be considered as sensitive information that a Merchant 1000 would not want to publish and make available for its competitors. For this reason all statistics generation or measure processing communication should preferably be encrypted.

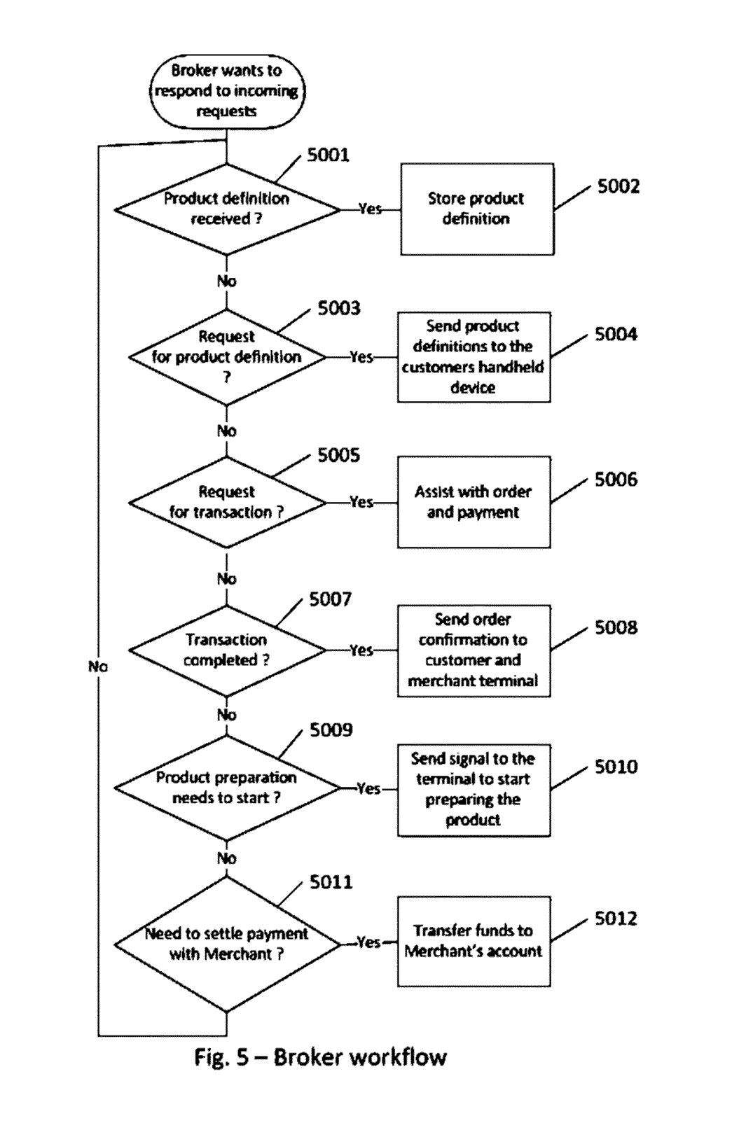

Referring to FIG. 5, an example workflow for the Broker is schematically illustrated. It will be appreciated that many of the steps of FIG. 5 have been referred to above, due to the interrelationship between FIGS. 2 to 5, and in particular between the Merchant, Customer, Assistant and Broker. In FIG. 5, the broker wants to respond to incoming requests. At a step 5001, it is determined if a product definition has been received. If so, the product definition is stored at a step 5002. If not, it is determined if a request for a product definition has been received at a step 5003. If so, the requested product definitions are sent to the customer's handheld device at a step 5004. Otherwise, it is determined at a step 5005 whether a request for a transaction has been received. If so, the broker device assists with the order and the payment at a step 5006. At a step 5007 it is determined if the transaction has been completed. If so, at a step 5008 an order confirmation is sent to the customer and the merchant terminal. At a step 5009 it is determined whether product preparation needs to start, If it does, then a signal is sent to the terminal to start preparing the product at a step S010. At a step S011 it is determined whether there is a need to settle payment with the Merchant. If so, funds are transferred to the Merchant's account at a step S012. Otherwise, the flow returns back to the start, and in particular to the step 5001.

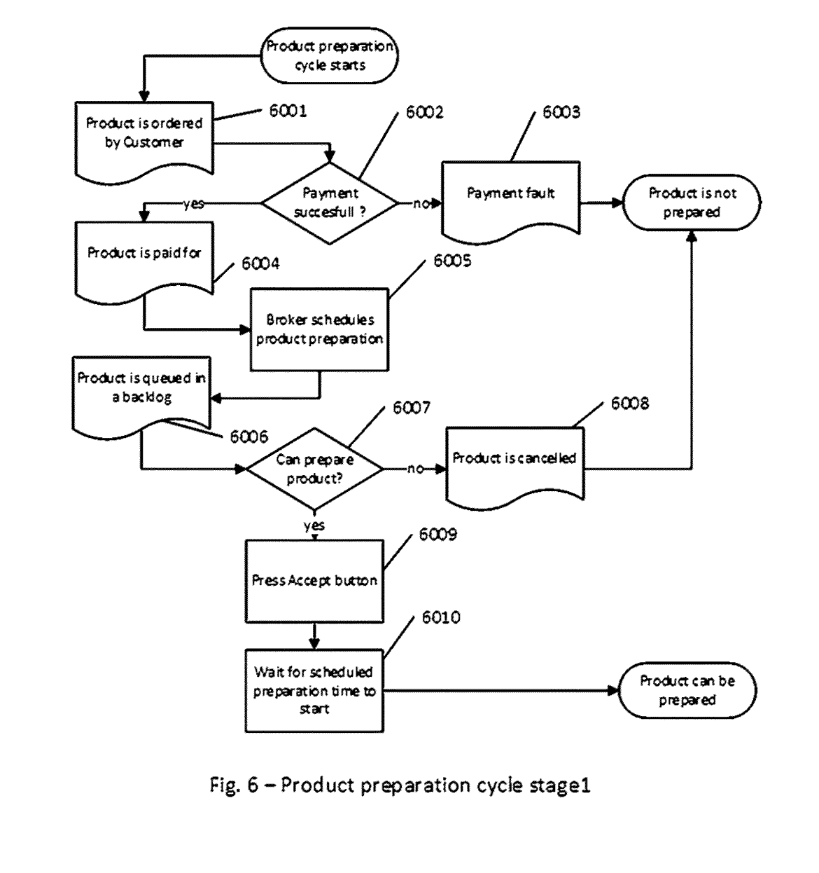

Stage 1 of a product preparation cycle is schematically illustrated in FIG. 6. In particular, once the product preparation cycle starts, a product is ordered by a customer at a step 6001. This will include a payment operation, which if found to be successful at a step 6002 will result in the product being paid for at a step 6004. If the payment is not successful, then at a step 6003 a payment fault will be generated, resulting in the product not being prepared. Once the product has been paid for at the step 6004, the broker schedules product preparation (as described above) at a step 6005. This may result in the product being queued in a backlog at a step 6006. It is then determined if the product can be prepared. If not, the product is cancelled at a step 6008, and is therefore not prepared at a step 6007. If it is determined at the step 6007 that the product can be prepared, then at 6009 an “Accept” button is pressed, and at a step 6010 the Assistant is required to wait for the scheduled preparation time to start, whereupon the product can be prepared.

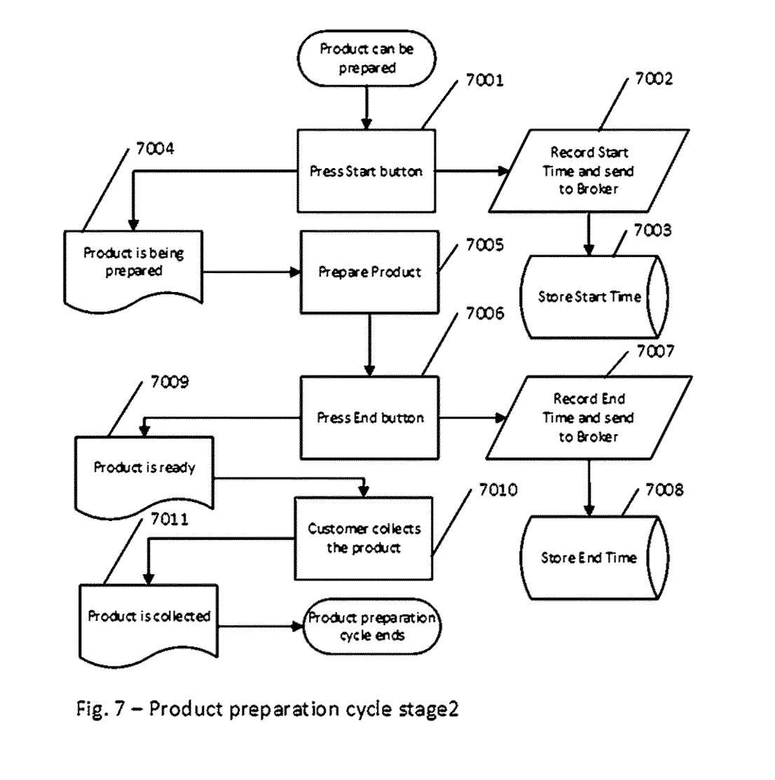

Stage 2 of the product preparation cycle is schematically illustrated in FIG. 7. Stage 2 follows directly on from Stage 1 as described in FIG. 6, and relates to product preparation, and the collecting of start and end times for product preparation. In particular, for collecting the start time and end time of the Product 1008 preparation an application could be used that displays a button for starting the Product 1008 preparation and finishing the Product 1008 preparation. The Assistant 1002 could press the start button at a step 7001 to indicate that the Product 1008 preparation has started, at this point at a step 7002 the system time could be recorded and sent to the Broker 1006 with the action description for storage at a step 7003. The service terminal may be responsive to the pressing of the start button to request the broker device to inform the customer that preparation of the product has started. Meanwhile, at a step 7004, following the pressing of the start button at the step 7001, the product is being prepared by the Assistant, and at a step 7005 the product preparation will be completed. Then, the Assistant 1002 could press the stop button at a step 7006 to indicate that the Product 1008 preparation has finished, and at this point the system time could be recorded and sent to the Broker 1006 at a step 7007 with the action description. The service terminal may be responsive to the pressing of the stop button to request the broker device to inform the customer that preparation of the product has been completed and that the product is ready for collection. The Broker 1006 could store this data in a database at a step 7008 and use it for calculating different measures, e.g. average Product 1008 preparation time or a bonus the Assistant 1002 needs to be paid for his work. Meanwhile, the product is deemed to be ready at a step 7009, following which the customer arrives to collect the product at a step 7010, and on release of the product to the customer the product is considered to be collected at a step 7011. The product preparation cycle then ends. It will be appreciated that the above (stage 2) process could be logged separately for different assistants to enable an accurate product preparation time to be estimated for a particular assistant allocated to the preparation of a product of the same type. In this way, the preparation time for a product can be determined based on the individual allocated to the preparation of the product. Alternatively, more general statistics could be generated, without reference to the performance of a particular assistant.

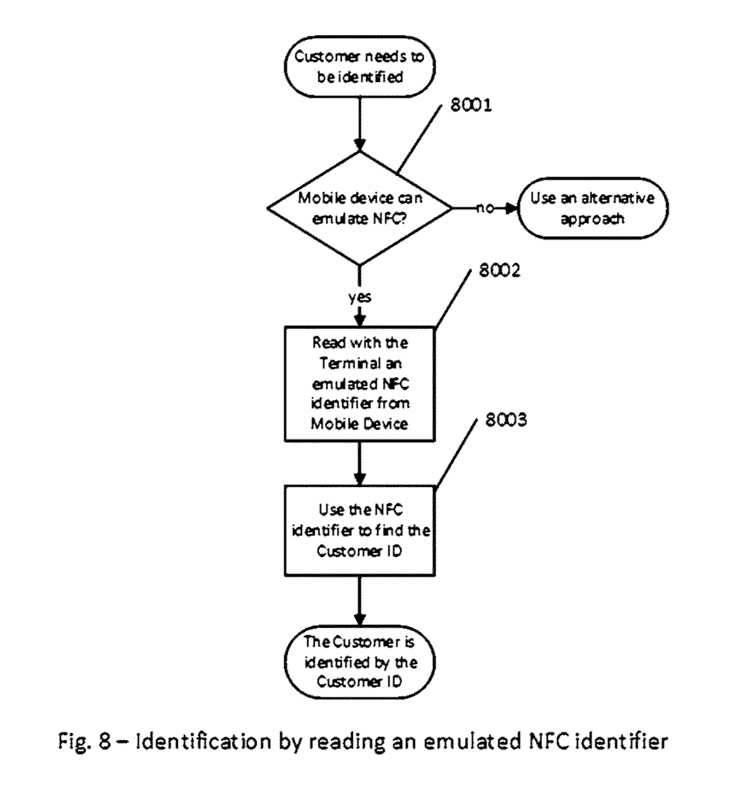

In one embodiment the identification could be done with adaptation of known technologies by reading with the Terminal 1005 the emulated NFC identifier from the Mobile Device 1004. An example of this is schematically illustrated in FIG. 8, which sets out steps required when the customer needs to be identified.
1. At a step 8001 it is determined whether the Mobile Device 1004 is able to emulate an NFC identifier. If the Mobile Device 1004 is not capable of this then an alternative approach is to be used.
2. At a step 8002, the Terminal 1005 reads off the emulated NFC identifier from the Mobile Device 1004.
3. At a step 8003 the Terminal 1005 uses the NFC identifier as a key to find the Customer ID in a lookup table. Then, the Customer 1001 is identified as the Customer 1001 who the Customer ID belongs to.

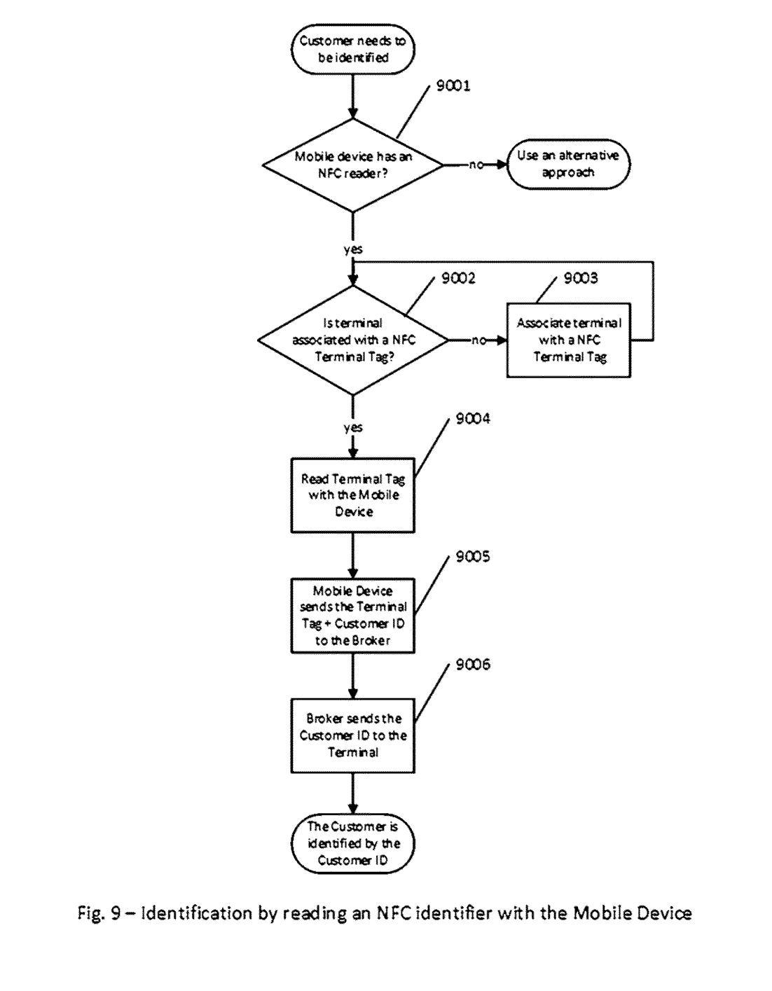

In one embodiment the identification could be done with adaptation of known technologies by reading a tag with the Mobile Device 1004. An example of this is schematically illustrated in FIG. 9, which sets out steps required when the customer needs to be identified.
1. At a step 9001 it is determined whether the Mobile Device 1004 is enabled with an NFC Reader and can read NFC identifiers. If it is not capable of doing this then an alternative approach is used.
2. Otherwise, at a step 9002 it is determined whether the terminal is associated with an NFC terminal tag, and if not then at a step 9003 the terminal is associated with an NFC terminal tag. In this way, at least one Terminal Tag is encoded into an NFC identifier and is associated with a Terminal 1005.
3. At a step 9004 the Mobile Device 1004 reads off an NFC identifier that that the Mobile Device 1004 can interpret as the Terminal Tag.
4. At a step 9005, the Mobile Device 1004 sends this Terminal Tag to the Broker 1006 along with the Customer ID.
5. At a step 9006 the Broker 1006 sends the Customer ID to the Terminal 1005 with which the Terminal Tag was associated.
6. The Customer 1001 is identified as the Customer 1001 who the Customer ID belongs to.

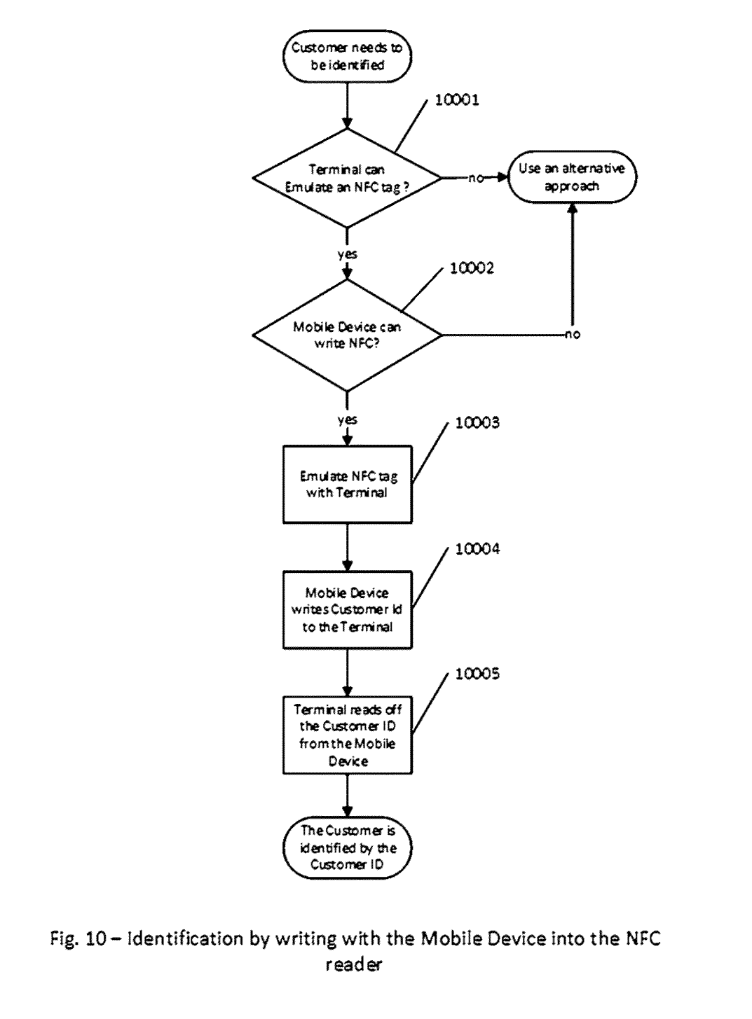

In one embodiment the identification could be done with adaptation of known technologies by writing with the Mobile Device 1004 into the NFC Reader. An example of this is schematically illustrated in FIG. 10, which sets out steps to be conducted for a customer who needs to be identified.
1. At a step 10001 it is determined whether the Terminal 1005 is able to emulate an NFC tag. If not, then an alternative approach to identification is used. Otherwise, at a step 10002 it is determined whether the Mobile Device 1004 is able to write to an NFC identifier. If not, an alternative approach to identification is used.
2. Otherwise, at a step 10003, the Terminal 1005 emulates an NFC tag.
3. At a step 10004, the Mobile Device 1004 tries to write information to the emulated NFC tag which in fact is the Terminal 1005, this information contains the Customer ID.
4. At a step 10005, he Terminal 1005 reads off the information from the Mobile Device 1004 with the Customer ID.
5. The Customer 1001 is then identified as the Customer 1001 who the Customer ID belongs to.

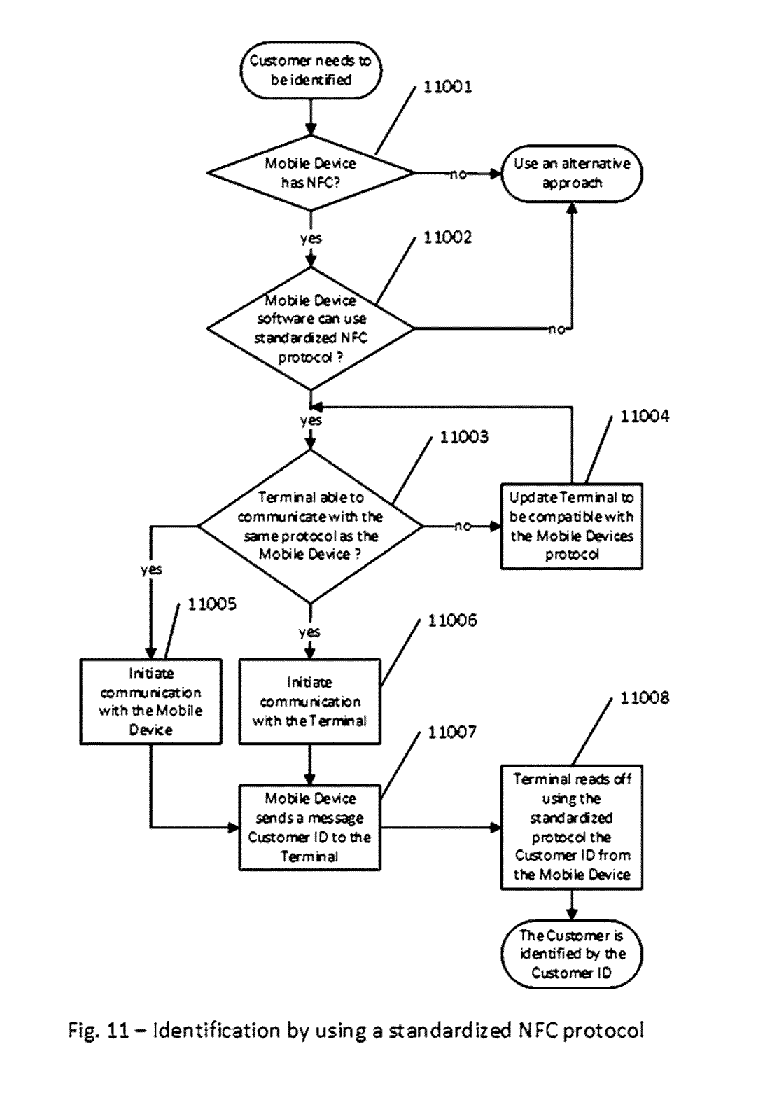

In one embodiment the identification could be done with adaptation of known technologies by using standardized NFC communications protocol. An example of this is schematically illustrated in FIG. 11, which sets out steps to be conducted for a customer who needs to be identified.
1. At a step 11001 it is determined whether the Mobile Device 1004 has a NFC Reader. If not, an alternative approach to identification is used. Otherwise, at a step 11002 it is determined whether the Mobile Device 1004 is equipped with software that is able to communicate with other NFC enabled devices using a standardized protocol. If not, an alternative approach to identification is used.
2. If the determinations made in the steps 11001 and 11002 are positive, then at a step 11003 it is determined whether the Terminal 1005 is equipped with or connected to an NFC Reader that is not able to communicate with the same protocol that the Mobile Device 1004. In this case, at a step 11004 the Terminal 1005 software has to be altered (update terminal) to make the Terminal 1005 compatible with the protocol of the Mobile Device 1004.
3. If the Terminal is compatible, then either the Terminal 1005 (at a step 11006) or the Mobile Device 1004 (at a step 11005) initiates the communication.
4. Either way, at a step 11007 the Mobile Device 1004 sends a message to the Terminal 1005 over the standardized protocol that contains the Customer ID.
5. Then at a step 11008, the Terminal 1005 receives a message over the standardized protocol from the Mobile Device 1004 with the Customer ID. The Terminal 1005 reads the Customer ID from the message using the standardized protocol.
6. The Customer 1001 is identified as the Customer 1001 who the Customer ID belongs to.

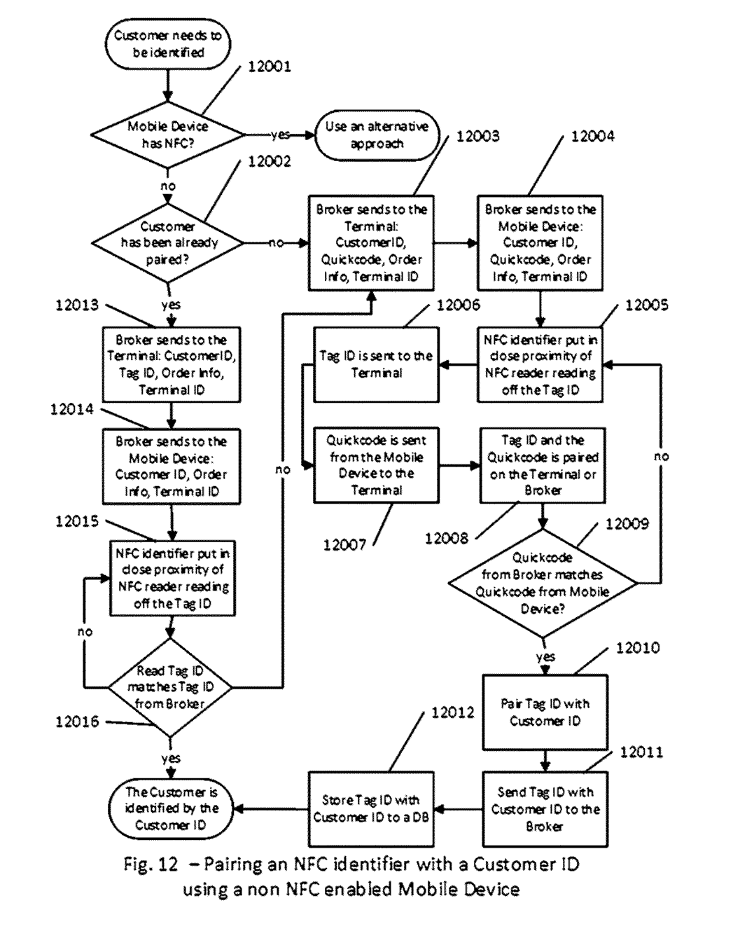

In one embodiment to pair an NFC identifier with a Customer ID using a non NFC enabled Mobile Device 1004, the following steps are conducted, as illustrated schematically in FIG. 12.
1. The Broker 1006 generates a Quickcode.
2. At a step 12001, it is determined whether the Mobile Device has an NFC capability. If so, an alternative NFC based method can be used. If not, it is determined at a step 12002 whether the Customer has already been paired. If not, at a step 12003 the Broker 1006 sends to the Terminal 1005 one or list of the following information paired together:
   a) Customer ID
   b) the Quickcode
   c) optionally an order information
   d) optionally the Terminal ID
3. Then, at a step 12004 the Broker 1006 sends to the Mobile Device 1004
   a) the Quickcode
   b) optionally Customer ID (the Customer ID could initially originate from the Mobile Device 1004 and be sent to the Broker 1006)
   c) optionally an order information
   d) optionally the Terminal ID
4. At a step 12005, the Customer 1001 or Assistant 1002 puts the NFC identifier in close proximity of the NFC Reader, thereby scanning the NFC identifiers Tag ID.
5. At a step 12006, the Tag ID is recognized and sent to the Terminal 1005.
6. At a step 12007, the Quickcode is also sent from the Mobile Device 1004 to the Terminal 1005. This could be done manually by the Customer 1001 reading it off from the screen to the Assistant 1002 and the Assistant 1002 inputting this information on the Tablet device, or it could be sent using any communication method the Mobile Device 1004 and Terminal 1005 can communicate with, for example Bluetooth, Wifi, AirDrop via Wifi, Visual, Sound, Electronic, Touch or any mobile sensor that is installed in any or both of the Mobile Device 1004 and Terminal 1005.
7. At a step 12008, the sent Tag ID and sent Quickcode from the Mobile Device 1004 are paired (on the Terminal 1005 or Broker 1006). In this way, it is possible to know which Tag ID belongs to which Quickcode.
8. At a step 12009, the sent Quickcode from the Broker 1006 to the Terminal 1005 and the sent Quickcode from the Mobile Device 1004 to the Terminal 1005 are matched i.e. it is possible to know:
   a) Tag ID <-> Quickcode from Mobile Device 1004
   b) Quickcode from Mobile Device 1004 <-> Quickcode from the Broker 1006
   c) Quickcode from the Broker 1006 <-> Customer ID
9. At a step 12010, if the Quickcodes are found to match at the step 12009, then the Tag ID is matched/paired with the Customer ID through a), b) and c) above. If a match is found the Customer 1001 can be granted access to the Product 1008 this first time.
10. At a step 12011, the Tag ID with its matched Customer ID is sent to the Broker 1006.
11. At a step 12012, on the Broker 1006 the Tag ID with its paired Customer ID could be stored to a database.
12. On subsequent transactions the Broker 1006 sends to the Terminal 1005 one or list of the following information paired together at a step 12013:
   a) Customer ID
   b) Tag ID
   c) optionally an order information
   d) optionally the Terminal 1005 ID
and the Broker 1006 sends to the Mobile Device 1004 one or list of the following information paired together at a step 12014:
   a) optionally Customer ID (the Customer ID could initially originate from the Mobile Device 1004 and sent to the Broker 1006)
   b) optionally an order information
   c) optionally the Terminal 1005 ID

Now the Tag ID sent from the Broker 1006 could be matched directly to the Tag ID read from the NFC Reader when the NFC identifier is put in close proximity to the NFC reader at a step 12015, thereby skipping steps 12007, 12008 and 12009; and given access to the Product 1008 at a step 12016 if they match or rejected if they don't.

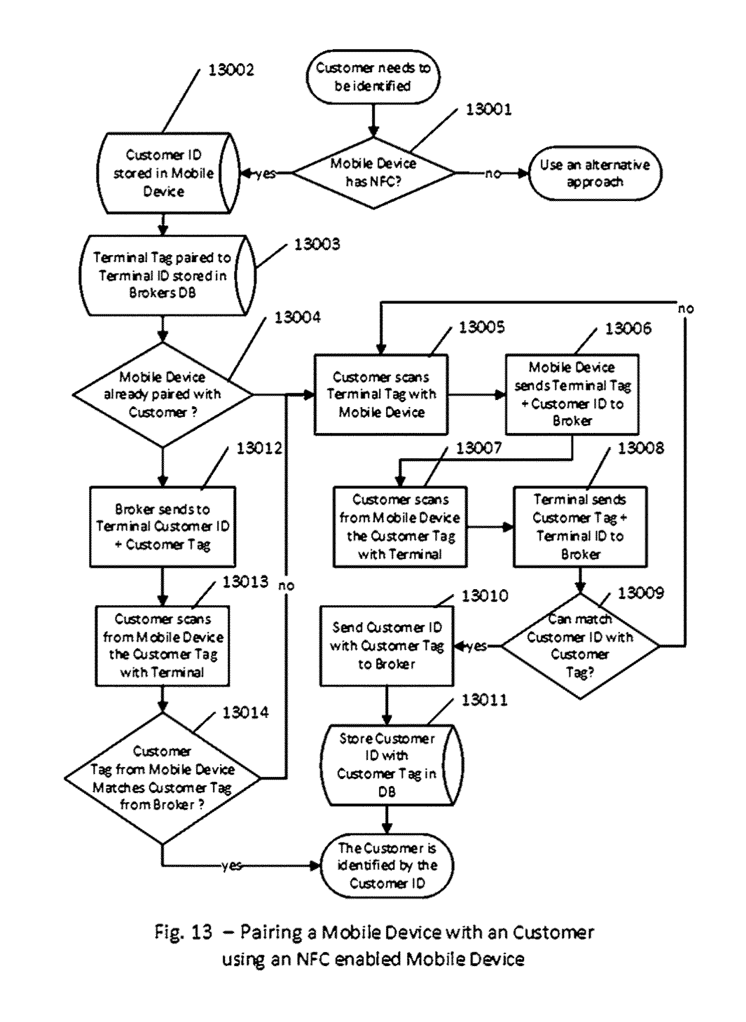

In one embodiment to pair a Mobile Device 1004 with an Customer ID using an NFC enabled Mobile Device 1004, the following steps are conducted, as schematically illustrated in FIG. 13.
1. At a step 13001, it is determined whether the Mobile Device has an NFC capability. If it does not, an alternative approach is used. If it does, then at a step 13002 the Customer ID is already stored on Mobile Device 1004.
2. At a step 13003, the Terminal Tag and Terminal ID are already stored on the Broker 1006 in a database, paired to each other.
3. At a step 13004, it is determined whether the Mobile Device is already paired with the customer. If not, then at a step 13005 the Customer 1001 scans the Terminal Tag with the Mobile Device 1004.
4. At a step 13006, the Mobile Device 1004 sends the Terminal Tag with Customer ID to the Broker 1006.
5. At a step 13007, the Customer 1001 scans Customer Tag on the Mobile Device 1004 with the Terminal 1005.
6. At a step 13008, the Terminal 1005 sends Customer Tag with Terminal 1005 ID to the Broker 1006.
7. At this point he Broker 1006 has the following information:
   a) Customer Tag <-> Terminal ID
   b) Terminal ID <-> Terminal Tag
   c) Terminal Tag <-> Customer ID
8. At a step 13009, the Broker 1006 matches the Customer ID with Customer Tag using the relationships a), b) and c) above. If a match cannot be found, the process returns to the step 13005.
9. If a match can be found at the step 13009, then at a step 13010 the Terminal 1005 sends the Customer ID with Customer Tag to the Broker 1006.
10. At a step 13011 the Broker 1006 stores the Customer ID with Customer Tag to a database.
11. If at the step 13004 it is determined that a pairing between the Mobile Device and Customer already exists, then at a step 13012, in subsequent transactions the Broker 1006 will send to the Terminal 1005 the following information
   a) Customer ID
   b) Customer Tag on the Mobile Device 1004
Now, when at a step 13013 the customer scans the Mobile Device 1004 tag with the Terminal 1005 can be directly matched at a step 13014 with the Mobile Device 1004 tag received from the Broker 1006 and the Customer 1001 can be granted access to the Product 1008 if they are the same or rejected if they are not.

### Operation:

The operation would involve typically the below steps (referencing steps from the drawings described above with the same reference numerals), typically but not necessarily in the order given below:
1. The Merchant 1000 uploads 2002 the Product 1008 definitions to the Broker 1006.
2. The Customer 1001 launches 3001 an application on a Mobile Device 1004.
3. The Mobile Device downloads the Product 1008 definitions from the Broker 1006.
4. The Customer 1001 uses the application to search 3002 for the Product 1008 he wishes to purchase and search 3003 for a Collection point he wishes to collect the Product 1008 from.
5. The Customer 1001 orders and pays for the product 3004.
6. The Broker 1006 sends the order confirmation to the Customer 1001 and Terminal 1005.
7. The Broker 1006 sends the product preparation schedule to the Terminal 1005.
8. The Terminal 1005 signals the Assistant 1002 to start preparing the product.
9. The Assistant 1002 prepares the product 4003 and updates the product status 4004,4005.
10. The product status is sent from the Terminal 1005 to the Broker 1006 and from the Broker 1006 to the Mobile Device.
11. The Customer 1001 visits 3006 the Collection point, and confirms his identity 3007 with the Terminal 1005.
12. The Assistant 1002 releases the product 4008 to the Customer 1001.

It will be appreciated that while the above description mainly uses the example of the acquisition (e.g. purchase) of a product, the invention is not limited to this. In another example, the above described techniques can be used to control the provision of a service to a customer, or the access of a customer to an area or event. In this case, at a broker device, an agreement to provide the service or access to the customer at a specified location is facilitated, and in response to the agreement, the broker device transmits a request to a service terminal at the specified location to provide the service to the customer, or to provide the customer with access to the area or event. Then, using the service terminal, it is possible to authenticate the identity of the customer prior to providing the service or access to the customer. For example, the service might be a beauty treatment, which the customer can pay for in advance using the above methods, and be provided with on arrival following authentication. Alternatively, access to an area might be access to a football stadium for example.

It will be understood that, while the description above mainly describes the purchase of products and services, the invention is not limited to this, and can be applied to any agreement to provide a customer with a product or service.

In some embodiments, the user may be able to find a product or it's promotion medium (e.g. leaflet, billboard or any other medium) physically instead of searching it on the mobile phone (or other portable electronic device). In this case, he may be able to scan the product or it's promotion medium using his mobile phone. This means that in this case the user could be already in the shop or at a place where the product is promoted and would use NFC or Bluetooth to scan some information stored on the product or promotion medium that can identify the product, or scan a QR code or a barcode to quickly find the product on his phone and add it to the basket. It will be appreciated that any other wireless method described above (WAN, WIFI, AirDrop, 3G, HSPA, Bluetooth, Visual, Sound, Electronic, Touch, Magnetic, Accelerometer or any mobile sensor that is installed in the Mobile Device) could also be used. It is appreciated that by scanning we also mean the possibility of receiving a wireless signal actively after requesting this signal to be received, or just passively without any request, through any wireless protocol (WAN, WIFI, AirDrop, 3G, HSPA, Bluetooth, Visual, Sound, Electronic, Touch, Magnetic, Accelerometer or any mobile sensor that is installed in the Mobile Device) in an area where the product or the product promotion medium is located. He would then pay for the product using his phone, bring the product to the counter (possibly on a tray) and identify himself in accordance with the above techniques and allow the assistant to see the payment confirmed on the terminal.

1. A method of controlling and reporting a product acquisition process, comprising the steps of:
at a broker device, facilitating an agreement to provide a product to a customer, the product to be made available at a specified location;
in response to the agreement, transmitting a request from the broker device to a service terminal at the specified location to make the product available at the specified location; and
authenticating the identity of the customer prior to release of the product.

2. A method of controlling the provision of a service to a customer, or the access of a customer to an area or event, comprising the steps of:
at a broker device, facilitating an agreement to provide the service or access to the customer at a specified location;
in response to the agreement, transmitting a request from the broker device to a service terminal at the specified location to provide the service to the customer, or to provide the customer with access to the area or event; and
authenticating the identity of the customer prior to providing the service or access to the customer.

3. A method according to claim 1, comprising transmitting a tag identifier corresponding to the customer from the broker device to the service terminal, wherein the identity of the customer is authenticated by comparing the tag identifier transmitted by the broker device with a tag identifier provided by the customer at the specified location.

4. A method according to claim 3, comprising associating the tag identifier with the customer at the broker device by scanning the tag identifier at the service terminal, inputting to the service terminal a code generated by a portable electronic device associated with the customer or generated by a server, transmitting the tag identifier and the code associated with the customer from the service terminal to the broker device, and associating the tag identifier with the customer via the received code.

5. A method according to claim 1, wherein the tag identifier is stored on a physical near field communication (NFC) tag or card, and is communicated to the service terminal by near field communication.

6. A method according to claim 5, comprising associating the tag identifier with the customer at the broker device by
transmitting, from the broker device to the service terminal, a user identifier corresponding to the customer in association with a code;
transmitting the code from the broker device to a portable electronic device associated with the user;
scanning the physical NFC tag to access the tag identifier of the physical NFC tag at the service terminal;
providing the code received at the portable electronic device to the service terminal and associating the received code with the tag identifier;
at the broker device or at the service terminal, associating the tag identifier with the customer using the association between the tag identifier and the code, the association between the user identifier and the code, and by matching the code received from the broker device with the code received at and provided by the portable electronic device.

7. A method according to claim 6, wherein if the code provided from the portable electronic device to the service terminal matches the code transmitted from the broker device to the service terminal, the identity of the customer is authenticated.

8. A method according to claim 6, comprising storing the tag identifier and the associated user identifier together in a database.

9. A method according to claim 1, wherein the tag identifier is a virtual tag stored on a portable electronic device associated with the customer, and is communicated to the service terminal by a wireless communication method.

10. A method according to claim 9, comprising pairing the portable electronic device with the customer by
scanning a physical NFC tag associated with the service terminal using the portable electronic device to access a tag identifier of the service terminal;
transmitting the tag identifier of the service terminal from the portable electronic device to the broker device along with a user identifier associated with the customer;
scanning the virtual tag of the portable electronic device using the service terminal;
transmitting the virtual tag of the portable electronic device from the service terminal to the broker device in association with a terminal identifier associated with the service terminal;
at the broker device, associating the received user identifier with the virtual tag of the portable electronic device using the association between the virtual tag of the portable electronic device and the terminal identifier, an association between the terminal identifier and the tag identifier of the service terminal stored in advance at the broker device, and the association between the tag identifier of the service terminal and the user identifier.

11. A method according to claim 10, comprising transmitting from the broker device to the service terminal the user identifier and the virtual tag, wherein if a virtual tag provided from the portable electronic device to the service terminal matches the virtual tag transmitted from the broker device to the service terminal, the identity of the customer is authenticated.

12. A method according to claim 1, wherein the identity of the customer is authenticated by
scanning a physical or virtual tag provided by the customer using the service terminal to obtain a tag identifier;
obtaining a user identifier associated with the tag identifier by referring to a look up table.

13. A method according to claim 1, wherein the identity of the customer is authenticated by
scanning a tag associated with the service terminal using a portable electronic device associated with the user to obtain a tag identifier of the service terminal;
transmitting the tag identifier of the service terminal from the portable electronic device to the broker device in association with a user identifier associated with the customer;
transmitting the user identifier received at the broker device from the portable electronic device to the service terminal corresponding to the tag identifier of the service terminal received at the broker device from the portable electronic device.

14. A method according to claim 1, wherein the identity of the customer is authenticated by using a portable electronic device associated with the customer, writing a user identifier associated with the customer into an Near Field Communication tag associated with the service terminal;
using the service terminal, reading the user identifier from the tag.

15-26. (canceled)

27. A method according to claim 1, wherein the broker device stored product definitions of products for purchase from services, the product definitions being available for viewing by customers.

28. A method according to claim 1, comprising
providing payment related information to a personal electronic device associated with a customer; and
notifying the service terminal that payment has been made.

30. A method according to claim 1, comprising
receiving at least one product definition information at a mobile device associated with a customer;
using the mobile device, selecting a product based on the product definition information;
determining a payment amount and crediting account;
determining a payment account from which payment is to be made;
using a payment service to perform the payment in relation to the selected product;
sending a payment confirmation to one or more of a service terminal, an assistant intended to prepare the product, and the customer.

31. A method according to claim 30, wherein the customer collects the product at a collection point and identifies himself to the assistant in order to receive the product.

32. A method according to claim 31, wherein identification information is exchanged between the mobile device and at least one service terminal, or between the mobile device and at least one assistant.

33. A method according to claim 32, wherein the identification is provided by exchanging information between the mobile device and at least one service terminal by near field communication.

34. A method according to claim 32, wherein the identification is carried out using a static ID, a dynamic ID or a pre-existing ID.

35. (canceled)

36. (canceled)

37. A method according to claim 34, wherein a customer tag is associated with a customer ID or a mobile device is paired with a customer ID by matching quickcodes.

38. A method according to claim 34, wherein a customer tag is associated with a customer ID or a mobile device is paired with a customer ID after a terminal tag is scanned with the mobile device and the customer tag is scanned with the service terminal thereby allowing a matching process using the terminal ID received from the service terminal and the terminal tag received from the mobile device.

39. A method according to claim 32, wherein identification information is exchanged by reading with the service terminal a simulated NFC identifier from the Mobile Device, by reading a tag with the mobile device, by writing with the mobile device into an NFC Reader or by using a standardized NFC communications protocol.

40-42. (canceled)

43. A method according to claim 30, wherein the product definition is provided by at least one service and is stored in at least one data store at at least one broker device.

44. A method according to claim 30, wherein the broker device sends product preparation scheduling information to at least one service terminal.

45. (canceled)

46. A method according to claim 30, wherein the assistant updates the product status on the service terminal and a product status is sent from the service terminal to the broker device and from the broker device to the mobile device.

47. A system for controlling and reporting a product acquisition process, or of controlling the provision of a service to a customer, or the access of a customer to an area or event, comprising:
a broker device, operable
to facilitate an agreement to provide a product to a customer, the product to be made available at a specified location, or to provide the service or access to the customer at a specified location; and
in response to the agreement, to transmit a request to make the product available at the specified location, or a request to provide the service to the customer, or to provide the customer with access to the area or event; and
a service terminal, operable
to receive the request, and to display an indication of the request; and
to authenticate the identity of the customer prior to release of the product or to providing the service or access to the customer.

48-67. (canceled)

68. The method of claim 1, comprising:
scanning a product or its promotion medium using a portable electronic device associated with the customer;
initiating payment for the scanned product using the portable electronic device; and
authenticating the identity of the customer using the portable electronic device.

69. The method of claim 1, wherein a quickcode represented by a set of characters, symbol or pictures is associated with a product, service or order in a deterministic, heuristic or random way.

70. The method of claim 1, comprising:
representing the product, service or order using a quickcode; and
using a portable electronic device, displaying the quickcode to identify the product, service or order to an assistant.
